(19) United States
(12) Patent Application Publication
(10) Pub. No.: US 2007/0279298 A1
(43) Pub. Date: Dec. 6, 2007

(54) Antenna module and wireless communication device using the same

(75) Inventors: Jan-Kwo Leeng, Longtan Township (TW); Cheng-Tang Lin, Hsinchu City (TW); Ching-I Ku, Jhubei City (TW); Cheng-Ting Chan, Jhubei City (TW); Yueh-Heng Chiang, Tainan City (TW)

Correspondence Address: RABIN & Berdo, PC, 1101 14TH STREET, NW, SUITE 500, WASHINGTON, DC, 20005, US

(73) Assignee: Quanta Microsystems, Inc., Taoyuan Shien (TW)

(21) Appl. No.: 11/528,622

(22) Filed: Sep. 28, 2006

(30) Foreign Application Priority Data
May 30, 2006 (TW) 95209434

(51) Int. Cl. H01Q 1/24

(52) U.S. Cl. 343/702

(57) ABSTRACT

An antenna module and a wireless communication device using the same are provided. The antenna module is used for receiving or transmitting at least a wireless signal. The antenna module includes three independent antennas each having a bottom end and a center line. The bottom ends are substantially disposed on the same plane. The bottom ends are substantially arranged in the shape of a regular triangle. Each distance between two neighboring bottom ends is larger than a quarter of the wavelength of the wireless signal. The included angle between each of the center lines and the plane substantially ranges from 50° to 80°.

This application claims the benefit of Taiwan application Serial No. 095209434, filed May 30, 2006, the subject matter of which is incorporated herein by reference.

### BACKGROUND OF THE INVENTION

1. Field of the Invention

The invention relates in general to an antenna module and a wireless communication device using the same, and more particularly to an antenna module receiving/transmitting industrial, scientific and medical (ISM) band wireless signals by a multiple input/multiple output (MIMO) and a wireless communication device using the same.

2. Description of the Related Art

The wireless communication system has gained significant advance both in the speed and the stability in transmission. The wireless communication system is now widely applied in data transmission of computer and network such as desk-top computer, notebook, personal digital assistant (PDA), mobile phone and global positioning system (GPS), bringing considerable convenience to people both in their everyday life and business.

The wireless communication system uses an antenna module to receive or transmit a wireless signal. However, after long distance transmission, the intensity of the wireless signal would fade out. The fading of the wireless signal occurs especially when there is an obstacle standing in the transmission path of the wireless signal such that the wireless signal is reflected, penetrated or scattered. Consequently, the signal-to-noise ratio would plunge, severely affecting the quality of signal transmission and reducing the transmission rate. Take the distance of 90 m for instance, the transmission rate of 802.11g signals would be reduced to 1-2 Mbps in average due to the fading of wireless signals.

Referring to FIG. 1, a diagram of a conventional wireless communication device 300 is shown. The wireless communication device 300 includes a monopole or a dipole antenna 310. In a free space, there is a near omni-directional radiation pattern in the horizontal direction (the X-Y plane) but almost no radiation in the vertical direction (the Z-direction).

Referring to FIG. 2, a diagram of another conventional wireless communication device 600 is shown. The wireless communication device 600 includes four antennas 610, 620, 630, and 640. The four antennas form an antenna array such that the four individual antennas 610, 620, 630, and 640 having special sizes can achieve maximum signal intensity when the four antennas 610, 620, 630, and 640 are incorporated in a particular direction.

However, there are multiple obstacles such as floor, walls or metals existing in residential environments, offices or plants and causing wireless signals to fade out. In the application of the wireless communication devices 300 and 600, the monopole antenna, the dipole antenna or the antenna array would easily experience a dead zone in the reception and transmission of wireless signals for deteriorating communication quality or reducing transmission rate. Therefore, how to develop an antenna module and a wireless communication device using the same to improve communication quality and increase transmission rate has become an imminent issue to be resolved.

### SUMMARY OF THE INVENTION

It is therefore an object of the invention to provide an antenna module and a wireless communication device using the same. Wherein the bottom ends of the three antennas are substantially arranged in the shape of a regular triangle. Each distance between two neighboring bottom ends is larger than a quarter of the wavelength of the wireless signal. The included angle between each center line of the antennas and the plane substantially ranges from 50° to 80° such that the antenna module forms a quasi-omnidirectional antenna. Thus, the antenna module and the wireless communication device using the same further have the advantages of reducing the dead zone in the reception and transmission of wireless signals, assuring the stability in the reception and transmission of wireless signals, increasing the reception and transmission rate of wireless signals, and enhancing the signal intensity in the reception and transmission of wireless signals.

The invention achieves the above-identified object by providing an antenna module. The antenna module is used for receiving or transmitting at least a wireless signal. The antenna module includes three independent antennas each having a bottom end and a center line. The three bottom ends are substantially disposed on the same plane. The three bottom ends are substantially arranged in the shape of a regular triangle. Each distance between two neighboring bottom ends is larger than a quarter of the wavelength of the wireless signal. The included angle between each of the center lines and the plane substantially ranges from 50° to 80°.

The invention further achieves the above-identified object by providing a wireless communication device. The wireless communication device includes a housing, three antennas and a processing unit. The housing has a surface. The three antennas are disposed outside a first housing for receiving and transmitting at least a wireless signal. The first housing is made from a metallic or non-metallic material. Each of the three antennas has a bottom end and a center line. The three bottom ends are disposed on the surface. The processing unit is electrically connected to the three antennas for processing the wireless signal. The three bottom ends are substantially arranged in the shape of a regular triangle. Each distance between two neighboring bottom ends is larger than a quarter of the wavelength of the wireless signal. The included angle between each of the three center lines and the surface substantially ranges from 50° to 80°. The three antennas are selectively enclosed inside a non-metallic second housing.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 (Prior Art) is a diagram of a conventional wireless communication device 300;

FIG. 2 (Prior Art) is a diagram of another conventional wireless communication device 600;

FIG. 3 is a diagram of a wireless communication device 100 according to the invention;

FIG. 4 is a top view of the wireless communication device 100 of FIG. 3;

FIG. 5 is a block diagram of the wireless communication device 100 of FIG. 3;

FIG. 6 is a diagram of an antenna module 110 of FIG. 3;

FIG. 7A˜7C are radiation patterns when the antenna module 110 of FIG. 3 operated at 2.45 GHz on the X-Y plane, the X-Z plane and the Y-Z plane respectively; and

FIG. 8A˜8C are radiation patterns when the antenna module 110 of FIG. 3 operated at 5.25 GHz on the X-Y plane, the X-Z plane and the Y-Z plane respectively.

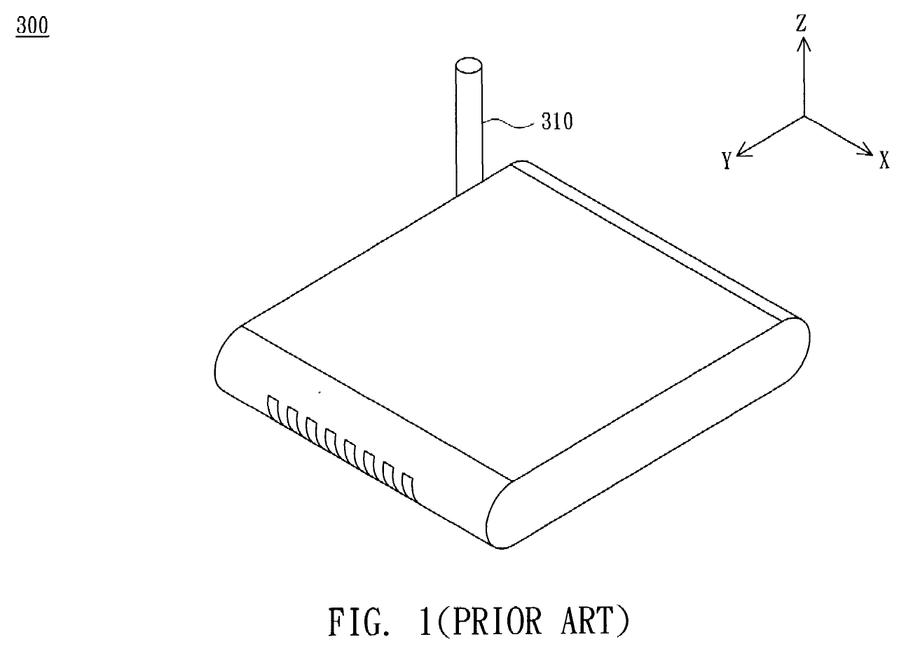

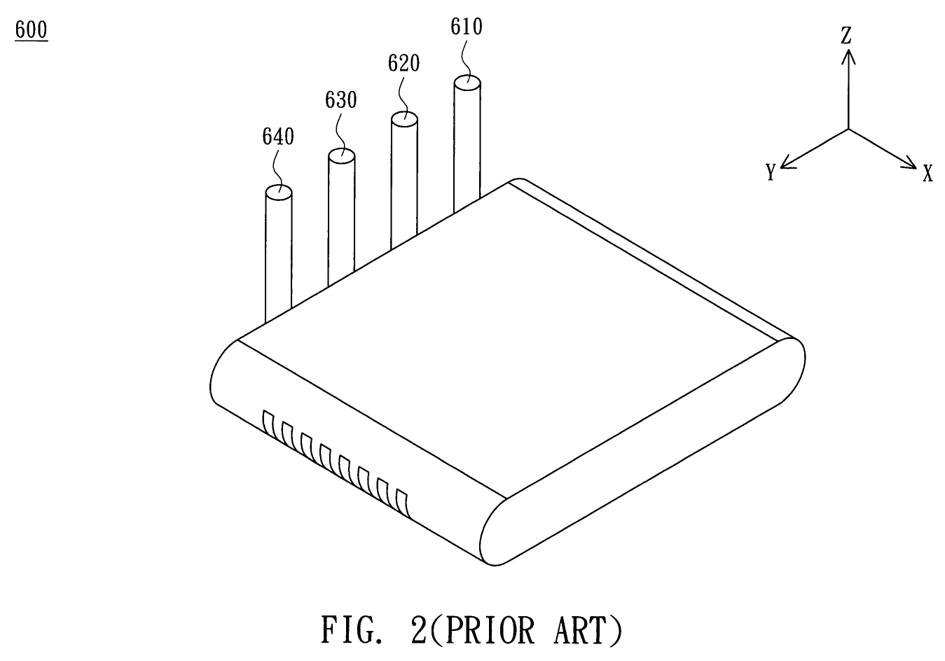

### DETAILED DESCRIPTION OF THE INVENTION

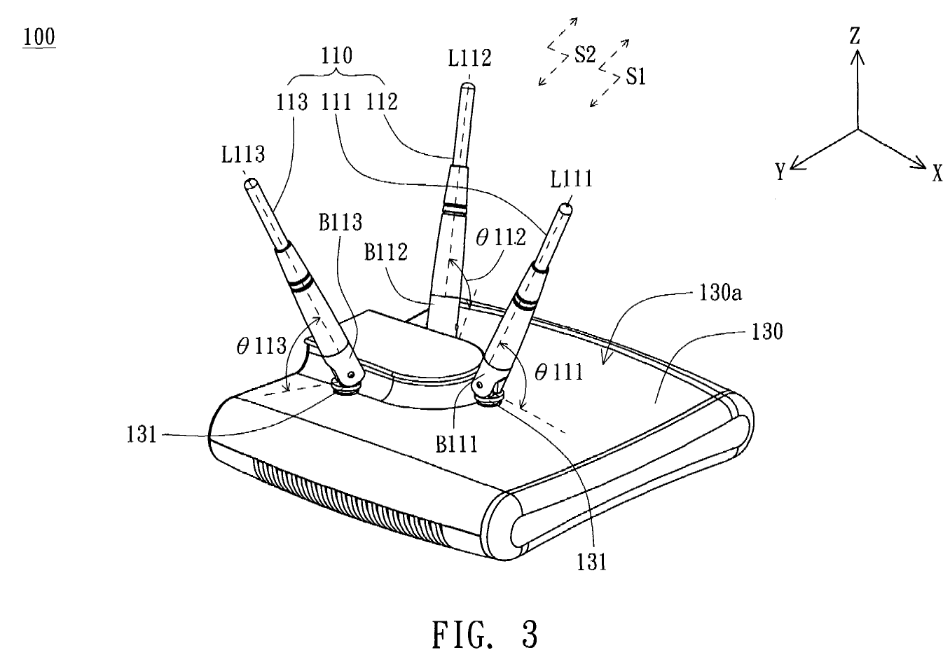

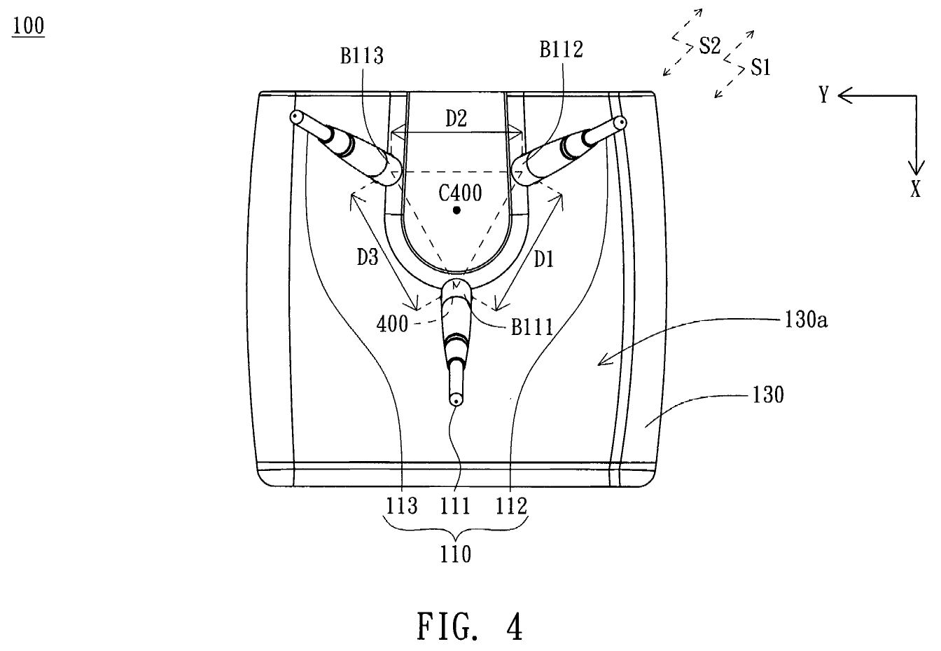

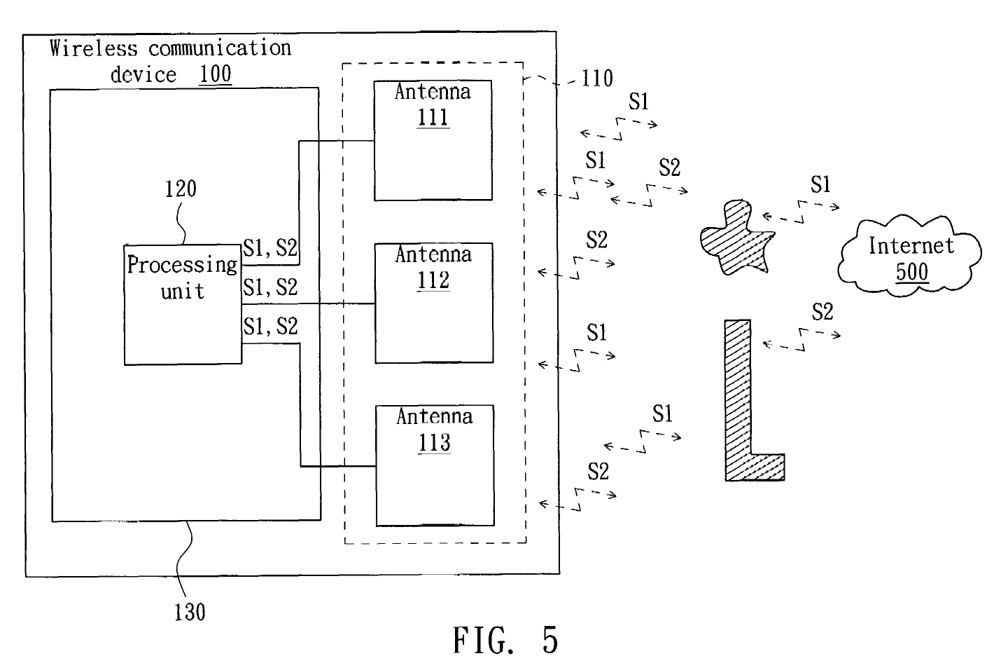

Referring to FIG. 3˜5. FIG. 3 is a diagram of a wireless communication device 100 according to the invention. FIG. 4 is a top view of the wireless communication device 100 of FIG. 3. FIG. 5 is a block diagram of the wireless communication device 100 of FIG. 3. The wireless communication device 100 includes a housing 130, an antenna 111, an antenna 112, an antenna 113 and a processing unit 120 (illustrated in FIG. 5). The housing 130 has a surface 130a. The antennas 111, 112, and 113 are disposed outside the housing 130 for receiving and/or transmitting at least a wireless signal. The antenna 111, 112 and 113 respectively have the bottom ends B111, B112 and B113 and the center lines L111, L112 and L113. The bottom ends B111, B112 and B113 are disposed on the surface 130a.

As shown in FIG. 3, the included angles θ111, θ112 and θ113 are respectively included between the center lines L111, L112 and L113 and the surface 130a. Each of the included angles θ111, θ112 and θ113 substantially ranges from 50° to 80°.

As shown in FIG. 4, the bottom ends B111, B112 and B113 are substantially arranged in the shape of a regular triangle 400. Each of the distances D1, D2 and D3 is larger than a quarter of the wavelength of the wireless signal. Of the three distances D1, D2 and D3, the distance D1 corresponds to the distance between bottom end B111 and the bottom end B112, the distance D2 corresponds to the distance between the bottom end B112 and the bottom end B113, and the distance D3 corresponds to the distance between bottom end B113 and the bottom end B111.

As shown in FIG. 5, the processing unit 120 is electrically connected to the antennas 111, 112 and 113 for processing at least a wireless signal.

According to the above disclosure, the antenna module 110 and a wireless communication device 100 using the same of the invention achieves a quasi-omnidirectional antenna by the characteristics of the above technology.

Examples of the wireless communication device 100 include wireless access point device, router, radio base station, TV, TV receiver and portable communication device such as notebook, personal digital assistant (PDA), mobile phone and global positioning system (GPS) reception device. The wireless communication device 100 has a large variety, and the invention is applicable to various electronic devices for receiving/transmitting a wireless signal.

The antennas 111, 112 and 113 are coaxial monopole antennas or coaxial dipole antennas with single band or dual band. In the present embodiment of the invention, the antennas 111, 112 and 113 are dual-band antennas capable of receiving/transmitting a number of first wireless signals S1 and second wireless signals S2. Examples of the frequency band of the first wireless signal S1 and the frequency band of the second wireless signal S2 include industrial, scientific and medical (ISM) band. The frequency band of the first wireless signals S1 ranges from 2.4 GHz to 2.5 GHz, and the frequency band of the second wireless signals S2 ranges from 4.9 GHz to 5.9 GHz.

As shown in FIG. 4, the distance D1 corresponds to the distance between bottom end B111 and the bottom end B112, the distance D2 corresponds to the distance between the bottom end B112 and the bottom end B113, and the distance D3 corresponds to the distance between bottom end B113 and the bottom end B111. The distances D1, D2 and D3 are substantially the same and each is larger than a quarter of the wavelength of the first wireless signal S1 and the second wireless signal S2. According to the results of experiments, the distances D1, D2 and D3 are substantially equal to 6 to 7 cm, such that the correlation coefficient among the antennas 111, 112 and 113 approaches zero. That is, the antennas 111, 112 and 113 are free of mutual interference when receiving or transmitting the first wireless signal S1 and the second wireless signal S2.

As shown in FIG. 4, the antennas 111, 112 and 113 are tilted outwards and radially from a central point C400 of the regular triangle 400, such that the wireless communication device 100 is almost free of dead zone in the reception and transmission of wireless signals.

According to the results of experiments, when the included angles θ11, θ112 and θ113 between the antennas 111, 112 and 113 and the surface 130a are substantially the same and range from 60° to 70°, the antenna module 110 and the wireless communication device 100 using the same achieves optimized reception and transmission of wireless signals.

As shown in FIG. 5, the processing unit 120 is disposed inside the housing 130. The antennas 111, 112 and 113 are disposed outside the housing 130 and are electrically connected to the processing unit 120. The housing 130 is made from a metallic or non-metallic material. After the first wireless signal S1 or the second wireless signal S2 is transmitted by the Internet 500, the first wireless signal S1 and the second wireless signal S2 will be reflected or scattered when encountering obstacles in the transmission path. After having been reflected or scattered, the first wireless signal S1 and the second wireless signal S2 are transmitted to the antennas 111, 112 and 113 in different angles with different levels of signal fading. Then after the antennas 111, 112 and 113 receive the first wireless signal S1 or the second wireless signal S2, the scattered first wireless signals S1 or second wireless signals S2 are collected to the processing unit 120. In the present embodiment of the invention, the processing unit 120 is a baseband integrated circuit (baseband IC), which modulates the scattered first wireless signal S1 or second wireless signal S2 according to the digital signal processing (DSP) technology.

To the contrary, the processing unit 120 can transmit the processed special signals to the Internet 500 via the antennas 111, 112 and 113. The antennas 111, 112 and 113 are capable of transmitting signals at the same time and avoiding the intensity of the first wireless signal S1 or the second wireless signal S2 being faded by a particular obstacle.

The antenna module 110 forms a multiple input/multiple output (MIMO) antenna module by incorporating the antennas 111, 112 and 113, not only reducing dead zone in the transmission and reception of wireless signals but also assuring the stability in the transmission and reception of wireless signals through the mutual support of the antennas.

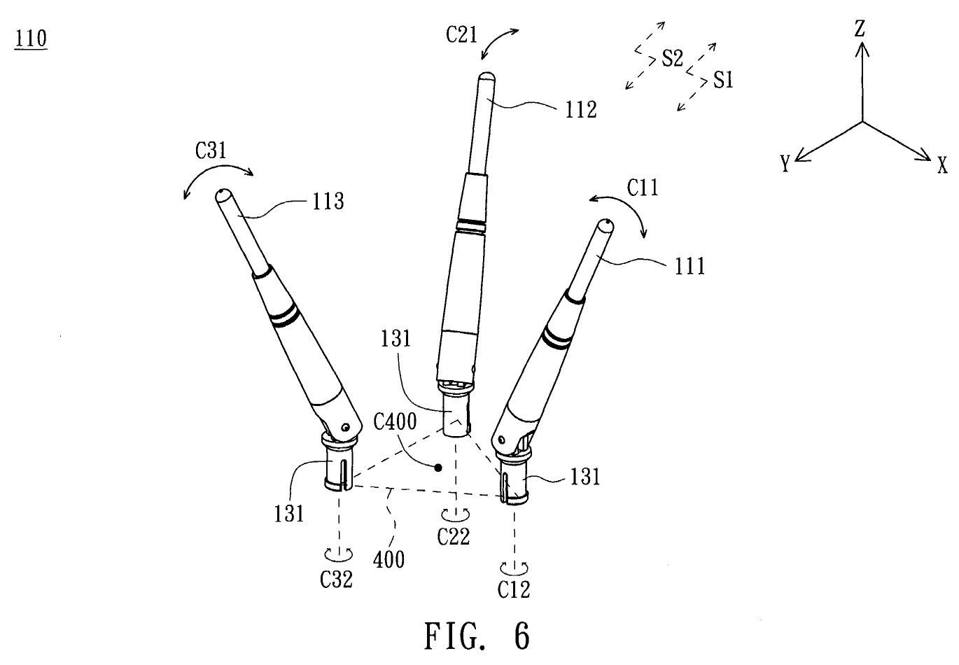

Referring to both FIG. 6 and FIG. 3. FIG. 6 is a diagram of an antenna module 110 of FIG. 3. The housing 130 has three pivots 131 via which the bottom ends B111, B112 and B113 are pivotally connected to the housing 130. When the antennas 111, 112 and 113 respectively use the bottom ends B111, B112 and B113 as an axis and swing around in the directions C11, C21 and C31, the antennas 111, 112 and 113 may stay close to or away from the surface 130a. By doing so, the antennas 111, 112 and 113 may swing to be positioned at a particular position such that the included angles θ111, θ112 and θ113 range from 50° to 80°, preferably, from 60° to 70°.

Moreover, the antennas 111, 112 and 113 may respectively swing around the bottom ends B111, B112 and B113 in the directions C12, C22 and C32. When the antennas 111, 112 and 113 stay close to the surface 130a and rotate in the directions C12, C22 and C32, the antennas 111, 112 and 113 are received inwardly to the surface 130a of the housing 130.

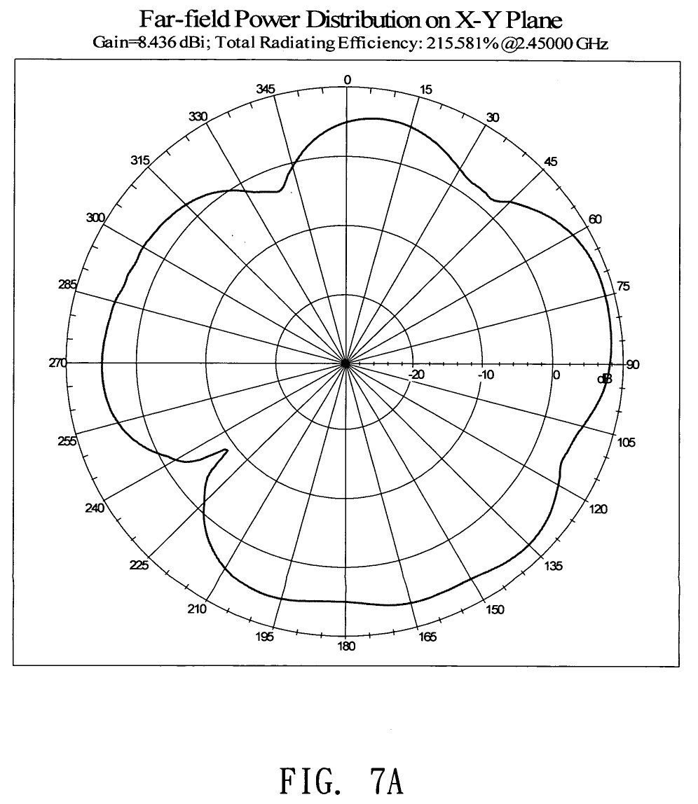

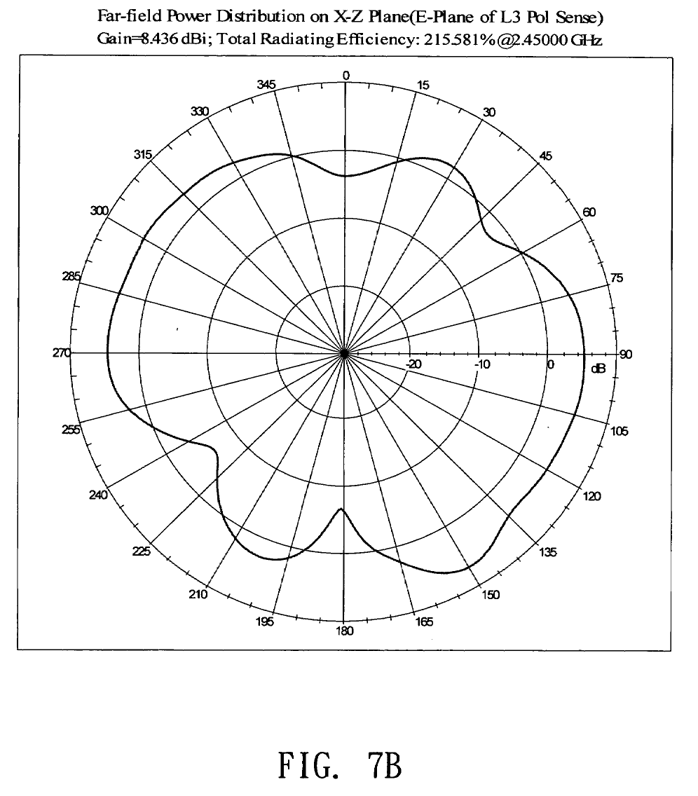

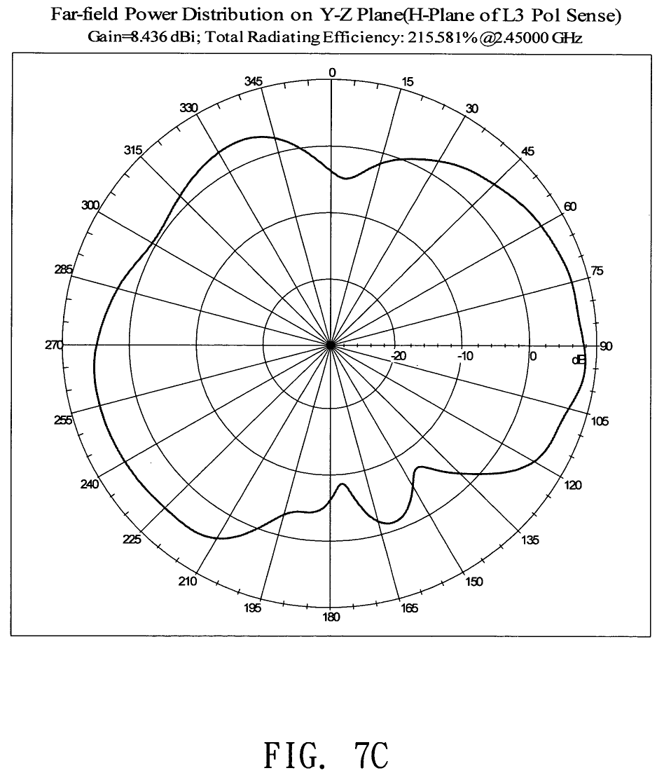

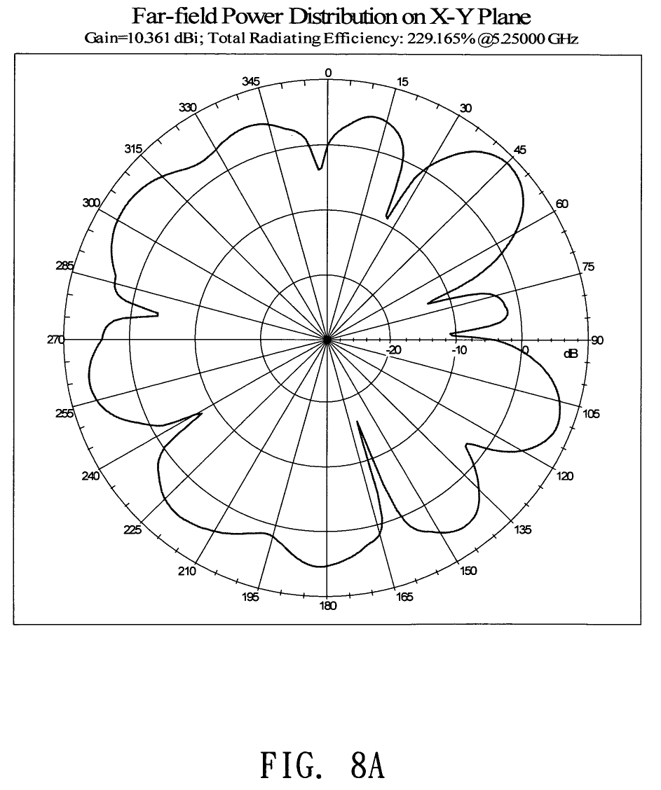

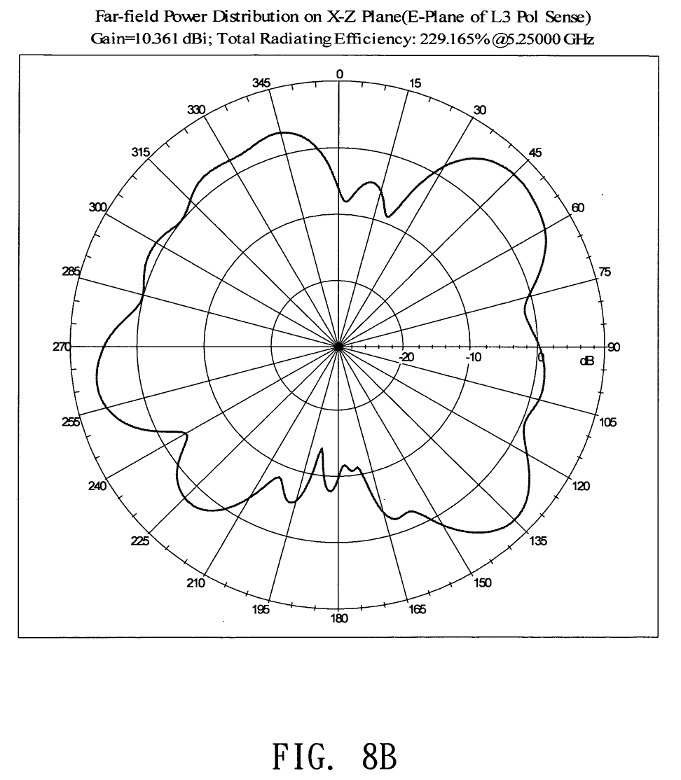

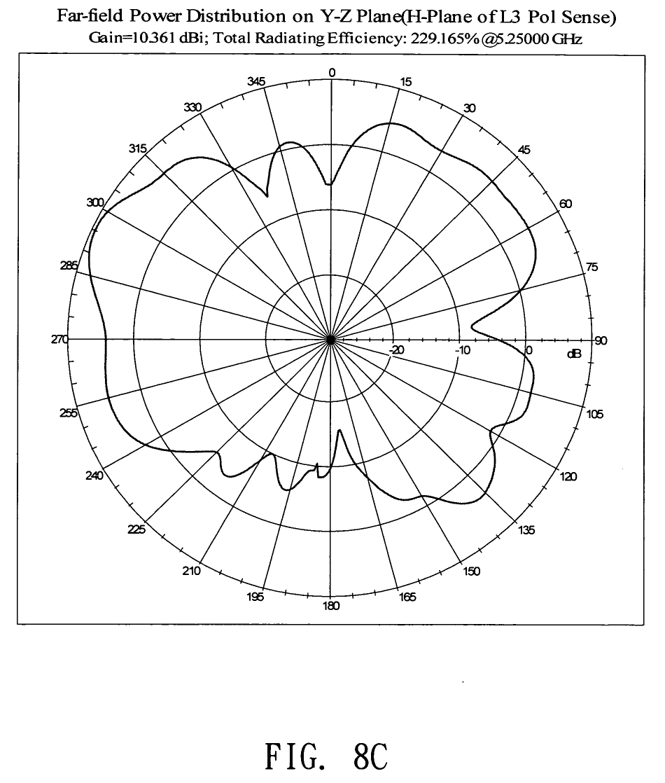

Referring to both FIG. 7A˜7C and FIG. 8A˜8C. FIG. 7A˜7B are radiation patterns when the antenna module 110 of FIG. 3 operated at 2.45 GHz on the X-Y plane, the X-Z plane and the Y-Z plane respectively. FIG. 8A-8C are radiation patterns when the antenna module 110 of FIG. 3 operated at 5.25 GHz on the X-Y plane, the X-Z plane and the Y-Z plane respectively. In the experiments of the antenna module 110 operated at 2.45 GHz and 5.25 GHz, the gain values of the antenna module 110 are 8.43552 dbi and 10.36062 dbi respectively. The received signal intensity is very uniform no matter on the X-Y plane, the X-Z plane or the Y-Z plane. According to the above results of experiments, the antenna module 110 of the invention and the wireless communication device 100 using the same achieve excellent communication quality.

Despite the antennas 111, 112 and 113 of the present embodiment of the invention are exemplified by dual-band antennas, the antennas 111, 112 and 113 can be single-band antennas. The antennas 111, 112 and 113 can be used only for receiving or transmitting a number of first wireless signals S1 or only for receiving or transmitting a number of second wireless signals S2. Any designs of quasi-omnidirectional antenna achieved by enabling the bottom ends of three antennas to be arranged in the shape of a regular triangle, the distances between the neighboring bottom ends to be larger than a quarter of the wavelength of the wireless signal and the included angle between each of the center lines and the surface to range from 50° to 80° are within the scope of the technology of the invention.

The wireless communication device 100 may further have another housing inside which the antennas 111, 112 and 113 are positioned. The other housing is made from a non-metallic material. For example, if the wireless communication device 100 is a TV, then the other housing is a housing of the TV in which the antennas 111, 112 and 113 are enclosed. The housing is made from a non-metallic material and will not affect the wireless transmission function of the antennas 111, 112 and 113.

According to the antenna module and the wireless communication device using the same disclosed in the above embodiments of the invention, the bottom ends of three antennas are substantially arranged in the shape of a regular triangle, and each distance between two neighboring bottom ends is larger than a quarter of the wavelength of the wireless signal. The included angle between each of the center lines and the plane substantially ranges from 50° to 80°, such that the antenna module become a quasi-omnidirectional antenna and the antenna module and the wireless communication device using the same are equipped with the following advantages:

Firstly, the dead zone in the reception and transmission of wireless signals is reduced. The three antennas are tilted outwards and radially from the central point of a regular triangle. The antenna module is capable of receiving and transmitting signals in multiple angles, so there is almost no dead zone in the reception and transmission of signals.

Secondly, the stability in the reception and transmission of wireless signals is assured. Since the distances between the bottom ends of the three antennas of the invention are larger than a quarter of the wavelength of the wireless signal, no mutual interference exists among the three antennas, the stability in the reception and transmission of wireless signals is enhanced, and stability is maintained during the reception and transmission of wireless signals

Thirdly, the reception/transmission rate of wireless signals is increased. The invention uses the above three antennas to transmit/receive wireless signal at the same time in a particular angle, and has a quasi-omnidirectional performance in reception and transmission. The amount of the data received/transmitted by the antenna module and the wireless communication device using the same disclosed in the invention within a unit time is largely increased. In other words, the reception and transmission rate of wireless signals is increased.

Fourthly, the signal intensity in the reception and transmission of wireless signals is enhanced. The reflected or scattered wireless signals are transmitted to the three antennas in different angles and with different level of signal fading. After having received the wireless signals, the three antennas collect the scattered wireless signals to a processing unit or the other way round, such that the signal-to-noise ratio in the reception and transmission of wireless signals is increased significantly.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An antenna module used for receiving or transmitting at least a wireless signal, the antenna module comprising:
three antennas each having a bottom end and a center line respectively, wherein the bottom ends are substantially disposed on the same plane;
wherein, the bottom ends are substantially arranged in the shape of a regular triangle, each distance between two neighboring bottom ends is larger than a quarter of the wavelength of the wireless signal, the included angle between each of the center lines and the plane substantially ranges from 50° to 80°.

2. The antenna module according to claim 1, wherein the distances substantially range from 6 to 7 cm.

3. The antenna module according to claim 1, wherein the included angle between each of the center lines and the plane substantially ranges from 60° to 70° and the included angles are substantially the same.

4. The antenna module according to claim 1, wherein the regular triangle has a central point, and the antennas are tilted outwards and radially from the central point.

5. The antenna module according to claim 1, wherein the antennas are coaxial monopole antennas or coaxial dipole antennas.

6. The antenna module according to claim 5, wherein the antennas are dual-band antennas.

7. The antenna module according to claim 6, wherein the antennas are used for receiving or transmitting a plurality of first wireless signals and second wireless signals, the frequency band of the first wireless signals ranges from 2.4 GHz to 2.5 GHz, and the frequency band of the second wireless signals ranges from 4.9 GHz to 5.9 GHz.

8. The antenna module according to claim 5, wherein the antennas are single-band antennas.

9. The antenna module according to claim 8, wherein the antennas are used for receiving or transmitting a plurality of first wireless signal, and the frequency band of the first wireless signals ranges from 2.4 GHz to 2.5 GHz.

10. The antenna module according to claim 8, wherein the antennas are used for receiving or transmitting a plurality of second wireless signal, and the frequency band of the second wireless signals ranges from 4.9 GHz to 5.9 GHz.

11. The antenna module according to claim 1, the antenna module is a multiple input/multiple output (MIMO) antenna module.

12. A wireless communication device, comprising:
a first housing having a surface;
three antennas disposed outside the first housing for receiving and transmitting at least a wireless signal, wherein each antenna respectively has a bottom end and a center line, and the bottom ends are disposed on the surface; and
a processing unit electrically connected to the antennas for processing the wireless signal;
wherein, the bottom ends are substantially arranged in the shape of a regular triangle, each distance between two neighboring bottom ends is larger than a quarter of the wavelength of the wireless signal, each included angle between the center lines and the surface substantially ranges from 50° to 80°.

13. The wireless communication device according to claim 12, wherein the distances substantially range from 6 to 7 cm.

14. The wireless communication device according to claim 12, wherein the included angle between each of the center lines and the plane substantially ranges from 600 to 700, the included angles are substantially the same, the regular triangle has a central point, and the antennas are tilted outwards and radially from the central point.

15. The wireless communication device according to claim 12, wherein the antennas are coaxial monopole antennas or coaxial dipole antennas.

16. The wireless communication device according to claim 15, wherein the antennas are dual-band antennas.

17. The wireless communication device according to claim 16, wherein the antennas are used for receiving or transmitting a plurality of first wireless signals and second wireless signals, the frequency band of the first wireless signals ranges from 2.4 GHz to 2.5 GHz, and the frequency band of the second wireless signals ranges from 4.9 GHz to 5.9 GHz.

18. The wireless communication device according to claim 15, wherein the antennas are single-band antennas.

19. The wireless communication device according to claim 18, wherein the antennas are used for receiving or transmitting a plurality of first wireless signal, and the frequency band of the first wireless signals ranges from 2.4 GHz to 2.5 GHz.

20. The wireless communication device according to claim 18, wherein the antennas are used for receiving or transmitting a plurality of second wireless signal, and the frequency band of the second wireless signals ranges from 4.9 GHz to 5.9 GHz.

21. The wireless communication device according to claim 12, wherein the wireless communication device is a wireless access point device.

22. The wireless communication device according to claim 12, wherein the wireless communication device is a router.

23. The wireless communication device according to claim 12, wherein the first housing has three pivots, and the bottom ends are pivotally connected to the first housing via the pivots.

24. The wireless communication device according to claim 23, wherein the antennas rotate around the pivots to adjust the positions of the antennas.

25. The wireless communication device according to claim 12, the wireless communication device is a multiple input/multiple output (MIMO) system.

26. The wireless communication device according to claim 12, wherein the processing unit is a baseband integrated circuit (baseband IC).

27. The wireless communication device according to claim 12, further has a second housing, the three antennas are positioned inside the second housing, and the second housing is made from a non-metallic material.
